(19) United States
(12) Patent Application Publication
(10) Pub. No.: US 2015/0105918 A1
(43) Pub. Date: Apr. 16, 2015

(54) METHOD AND APPARATUS FOR CONTROLLING INDOOR TEMPERATURE BASED ON INFORMATION ABOUT MOVING USER

(71) Applicant: Samsung Electronics Co., Ltd., Gyeonggi-do (KR)

(72) Inventor: Yong Oh LEE, Gyeonggi-do (KR)

(73) Assignee: Samsung Electronics Co., Ltd.

(21) Appl. No.: 14/515,093

(22) Filed: Oct. 15, 2014

(30) Foreign Application Priority Data
Oct. 15, 2013 (KR) 10-2013-0122749

(51) Int. Cl. F24F 11/00; G05B 15/02; F24D 19/10

(52) U.S. Cl. CPC F24F 11/006; F24F 11/0012; F24F 11/0015; F24F 11/0034; F24F 11/0076; F24D 19/1084; G05B 15/02; F24F 2011/0013; F24F 2011/0016; F24F 2011/0035; F24F 2011/0038; F24F 2011/0049; F24F 2011/0063; F24F 2011/0072
USPC 700/276

(57) ABSTRACT

A method for controlling an indoor temperature based on information about a moving user is provided. The method includes determining a temporary set temperature using weather information of user's current location and current time; and determining a final set temperature by reflecting a change in the weather information caused by movement of the user based on the temporary set temperature.

### PRIORITY

This application claims priority under 35 U.S.C. §119(a) to a Korean Patent Application filed in the Korean Intellectual Property Office on Oct. 15, 2013 and assigned Serial No. 10-2013-0122749, the entire content of which is incorporated herein by reference.

### BACKGROUND

1. Field of the Invention

The present invention generally relates to a method and apparatus for controlling the indoor temperature, and more particularly, to a method and apparatus for controlling the indoor temperature according to the user desired condition, using automated Heating Ventilation and Air Conditioning (HVAC) control technology.

2. Description of the Prior Art

The automated HVAC control technology is most suitable for controlling HVAC with minimal user intervention, taking into account the air's temperature, humidity, flow, and the like, in an indoor space. For this HVAC control technology, the range of its use has been gradually expanding to hospitals, hotels, and the like.

A sensible temperature refers to the temperature that a person feels in a specific environment, and the sensible temperature, in which the wind velocity, humidity, solar irradiation, and the like, are reflected, may be different from the temperature measured by a thermometer. Therefore, there is a need to control the indoor temperature in consideration of the sensible temperature. However, the conventional HVAC control technology may have limitations in using personal status information of the user, or may not directly reflect the user's sensible temperature. The conventional related technologies only include the technology for checking the body's response using a sensor mounted on the user and controlling the indoor temperature according thereto. There are many environmental constraints in implementing this technology, in which a sensor needs to be mounted on the user, making it difficult to commercialize this technology.

### SUMMARY

The present invention has been made to address at least the above-mentioned problems and/or disadvantages and to provide at least the advantages described below. Accordingly, an aspect of an embodiment of the present invention is to provide a method and apparatus for controlling an indoor temperature taking into account the change of user environment, even if the user's environment changes significantly.

Another aspect of an embodiment of the present invention is to provide a method and apparatus for setting a temperature appropriate for a user based on weather information about a departure area and a new area in which the user will stay.

Another aspect of an embodiment of the present invention is to provide a method and apparatus for recognizing a change in room temperature and environment setting, setting preferences of a user based on the sensible temperature, and setting a temperature appropriate for the user based on the preferences of the user, when the user stays in a new area.

Another aspect of an embodiment of the present invention is to provide a method and apparatus for defining user's past lodging information and/or departure area information, current local weather information, user's room temperature setting pattern information, and time information, and comparing the defined information with each other to set a temperature.

In accordance with an aspect of the present invention, a method for controlling an indoor temperature based on information about a moving user is provided. The method includes determining a temporary set temperature using weather information of user's current location and current time; and determining a final set temperature by reflecting a change in the weather information caused by movement of the user based on the temporary set temperature.

In accordance with another aspect of the present invention, an apparatus for controlling an indoor temperature based on information about a moving user is provided. The apparatus includes a temperature setting operation unit configured to determine a temporary set temperature using weather information of user's current location and current time, and to determine a final set temperature by reflecting a change in the weather information caused by movement of the user based on the temporary set temperature; and a communication unit configured to exchange information with an external device under control of the temperature setting operation unit.

In accordance with another aspect of the present invention, a Heating Ventilation and Air conditioning (HVAC) system for controlling an indoor temperature based on information about a moving user is provided. The HVAC system includes a temperature setting operation unit configured to determine a temporary set temperature using weather information of user's current location and current time, and to determine a final set temperature by reflecting a change in the weather information caused by movement of the user based on the temporary set temperature; and a communication unit configured to exchange information with an external device under control of the temperature setting operation unit.

### BRIEF DESCRIPTION OF THE DRAWINGS

The above and other aspects, features and advantages of certain embodiments of the present invention will be more apparent from the following description, taken in conjunction with the accompanying drawings, in which:

FIG. 1 illustrates a configuration of an HVAC system according to an embodiment of the present invention;

FIG. 2 is a flow diagram illustrating a control procedure between system components according to an embodiment of the present invention; and

FIG. 3 is a flowchart illustrating a process of determining a room temperature according to an embodiment of the present invention.

Throughout the drawings, like reference numerals will be understood to refer to like parts, components, and structures.

### DETAILED DESCRIPTION OF EMBODIMENTS OF THE PRESENT INVENTION

The following description with reference to the accompanying drawings is provided to assist in a comprehensive understanding of embodiments of the invention as defined by the claims and their equivalents. It includes various specific details to assist in that understanding but these are to be regarded merely as examples. Accordingly, those of ordinary skilled in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to their meanings in a dictionary, but, are merely used to enable a clear and consistent understanding of the invention. Accordingly, it should be apparent to those skilled in the art that the following description of embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including, for example, tolerances, measurement errors, measurement accuracy limitations and other factors known to those of skill in the art, may occur in amounts that do not preclude the effect the characteristic intended to provide.

In accordance with an embodiment of the present invention, an HVAC system of the present invention may include a temperature setting operation unit, a temperature setting storage unit and a communication unit. Although the temperature setting operation unit and the temperature setting storage unit are included in the HVAC system in an embodiment of the present invention, the temperature setting operation unit and the temperature setting storage unit may be implemented as independent devices each including a function of the communication unit. The HVAC system may also be implemented as a single device that can perform all functions of the temperature setting operation unit, the temperature setting storage unit, and the communication unit.

Although it will be assumed herein that a room user staying at a hotel sets the temperature in the room, it will be apparent to those of ordinary skill in the art that the present invention may be applied to hospitals, department stores, shops, homes, other accommodations, and other amenities, all of which employ the HVAC system.

Hereinafter, a user of a hotel room will be used as an example to describe an embodiment of the present invention.

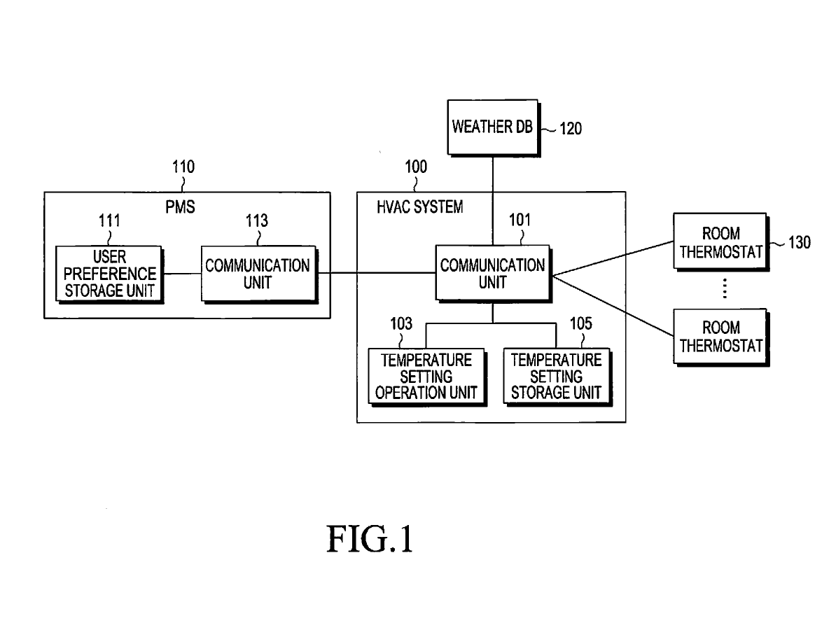

FIG. 1 illustrates a configuration of an HVAC system according to an embodiment of the present invention.

Referring to FIG. 1, the overall configuration of an embodiment of the present invention includes an HVAC system 100, a Property Management System (PMS) 110, a weather Database (DB) 120, and a room thermostat 130 in at least one room in the hotel. The PMS 110 includes, for example, a hotel information system used for management of the hotel facilities.

The HVAC system 100 is a device or system that can calculate the user's sensible temperature, using the weather information received from the weather DB 120 and the user information received from the PMS 110, and can control or adjust the set temperature in the room using the above information.

The HVAC system 100, for example, is installed inside the hotel building, or implemented outside the hotel building as a separate device.

The HVAC system 100 includes a communication unit 101, a temperature setting operation unit 103 and a temperature setting storage unit 105.

The temperature setting operation unit 103 obtains information about the area (e.g., the area in which the user has stayed before arriving at the hotel) from which the user departed, from a user preference storage unit 111 in the PMS 110. The information about the area where the user has stayed includes, for example, information about the travel area where the user has stayed before arriving at the hotel where he/she now stays, or the area where the user usually lives. In other words, the information about the area where the user has stayed includes the check-in time and check-out time at the departure area or sojourn area, the room temperature adjusted by the user during the stay, and the time the adjusted room temperature was changed.

The temperature setting operation unit 103 obtains hourly weather information for a desired area from the weather DB 120. The weather information includes information about the temperature, humidity, wind velocity, solar irradiation, and the like. The weather information may further include information about the yellow dusts, hails, hurricanes, and the like.

The temperature setting operation unit 103 calculates a temperature suitable for the user, based on the information received from the weather DB 120 and the information received from the user preference storage unit 111 in the PMS 110, and reflects the calculated temperature in the temperature in the room.

Reflecting the calculated temperature in the temperature in the room corresponds to controlling the room thermostat 130 mounted in the room so that the temperature in the room may be adjusted to the calculated temperature. In other words, reflecting the calculated temperature in the temperature in the room corresponds to controlling an element related to the humidity or the user's sensible temperature using a humidity control device or a wind velocity control device mounted in the room.

The temperature setting storage unit 105 stores the temperature calculated by the temperature setting operation unit 103, and also stores information about the set temperature and the time given when there is a change in the set temperature in the room where the user says. In other words, the temperature setting storage unit 105 receives, from the room thermostat 130, information about the temperature that the user has changed until his/her check out and the time at which the user has changed the temperature, stores the received information, and transmits the stored information to the user preference storage unit 111 in the PMS 110. The temperature setting storage unit may further calculate the sensible temperature by obtaining information about the temperature, humidity, wind velocity, solar irradiation, and the like, from the weather DB at each time of a change in the set room temperature from the user's check-in time to check-out time, and transmits the calculated sensible temperature to the PMS 110. The transmitted sensible temperature may be stored in the user preference storage unit 111 in the PMS 110 together with the changed temperature and time information.

The temperature setting storage unit 105 stores, for example, the temperature and time information, and also stores the user's sensible temperature-related information such as humidity, wind velocity, solar irradiation, and the like.

The communication unit 101, a component via which the HVAC system 100 can receive information from an external device and transmit information to the external device, exchanges information with the weather DB 120, the PMS 110 and the room thermostat 130. For example, the information includes the information calculated by the temperature setting operation unit 103 and the information stored by the temperature setting storage unit 105. The information, which is information that the communication unit 101 can receive from the external device, may further include information provided by the room thermostat 130, the weather DB 120, or the PMS 110.

The PMS 110 according to an embodiment of the present invention is a device or system that can store information about the location in the area where each user has stayed, the time at which the user has stayed in the area, and the temperature that the user set in the location of the area at the time, and can transmit the information at the request of the HVAC system 100. The PMS 110 may further store the user's sensible temperature information at the time in addition to the temperature that the user set in the location of the area at the time. The PMS 110 may additionally store or update information (e.g., a user IDentifier (ID)) for identifying the user, based on the user information received from the HVAC system 100.

The above-described operation of the PMS 110 may be replaced by an operation of an external server. In other words, the external server may store information including the information about the location in the area where the user has stayed, the time at which the user has stayed in the area, and the temperature that the user set in the location of the area at the time. Accordingly, the external server may receive the information from the HVAC system 100, and send the information at the request of the HVAC system 100.

The PMS 110 includes the user preference storage unit 111 and a communication unit 113.

The user preference storage unit 111 stores information about the area where the user has stayed before. For example, the information about the area where the user has stayed before includes information about the area (e.g., the area in which the user has stayed before arriving at the hotel) from which the user departed, and the time at which the user has stayed in the area.

As another example, the information about the area where the user has stayed before includes information about the travel area where the user has stayed before arriving at the hotel where he/she now stays, or the area where the user usually lives, and may further include user information for the area (e.g., information about the check-in time and check-out time at the departure area or sojourn area, and the temperature and time given when there is a change in the room temperature setting by the user during the stay). This information may be transmitted via the communication unit 113 in the PMS at the request of the HVAC system 100.

The user preference storage unit 111 stores the user's room temperature setting pattern information. The user's room temperature setting pattern information includes, for example, the room environment in the building, which was set by the user when the user departed for the area where he/her has stayed before, or for the current area. In other words, the user's room temperature setting pattern information includes the temperature in the room that the user has set, and the time the user has set the room temperature. The user's room temperature setting pattern information may further include the sensible temperature information at the time of setting the room temperature. Thus, the HVAC system 100 may extract the user-preferred set temperature or setting pattern corresponding to the sensible temperature using the information stored in the user preference storage unit 111.

The user preference storage unit 111 in the PMS 110 may be installed as a separate server, instead of existing inside the PMS 110. In other words, the user preference storage unit 111 in the PMS 110 may be installed as a secured separate device because the user preference storage unit 111 stores user's personal information.

The communication unit 113 in the PMS 110 transmits information at the request of the HVAC system 100, and receives hourly weather information for a desired area from the weather DB 120. The weather information includes the temperature, humidity, wind velocity and solar irradiation, and may further include the yellow dusts, hails, hurricanes, and the like.

The PMS 110 stores the information that the user has input in advance, in a separate server, and transmits the information at the request of the HVAC system 100. For example, the user accesses a separate server connected to the PMS 110, and inputs or enters information about his/her preferred temperature, humidity, and the like, to the separate server. The information entered by the user includes, for example, information about the user's heath condition or the user's preferred environment, and may further include the temperature, humidity, and other environmental preferences that the user can set using available state conversion devices in the room. The state conversion devices include, for example, a thermostat, a humidity control device, a wind speed control device, and the like.

The room thermostat 130 controls the temperature in the room depending on the temperature that is set by the HVAC system 100. The room thermostat 130 checks a change in the temperature set by the user staying in the room on the basis of time, and transmits the time information and set temperature information at the time of the change, to the HVAC system 100.

The room thermostat 130 sets the temperature requested by the HVAC system 100. The user may newly set a temperature other than the set temperature. If a new temperature is set by the user, the room thermostat 130 transmits the newly set temperature and time to the HVAC system 100. The room thermostat 130 provides a comfortable environment to the user, using other state conversion devices in the room. The room thermostat 130 may also transmit information about the room environment that is set using the state conversion devices, to the HVAC system 100.

The weather DB 120 stores the current and past weather information for a specific area. The weather DB 120 may also store the expected weather information for the future. The weather information includes the temperature, humidity, wind velocity and solar irradiation, and may further include information about the yellow dusts, hails, hurricanes, and the like.

The weather information in the weather DB 120 may be transmitted to the PMS and the HVAC system 100 at the request of the PMS 110 or the HVAC system 100.

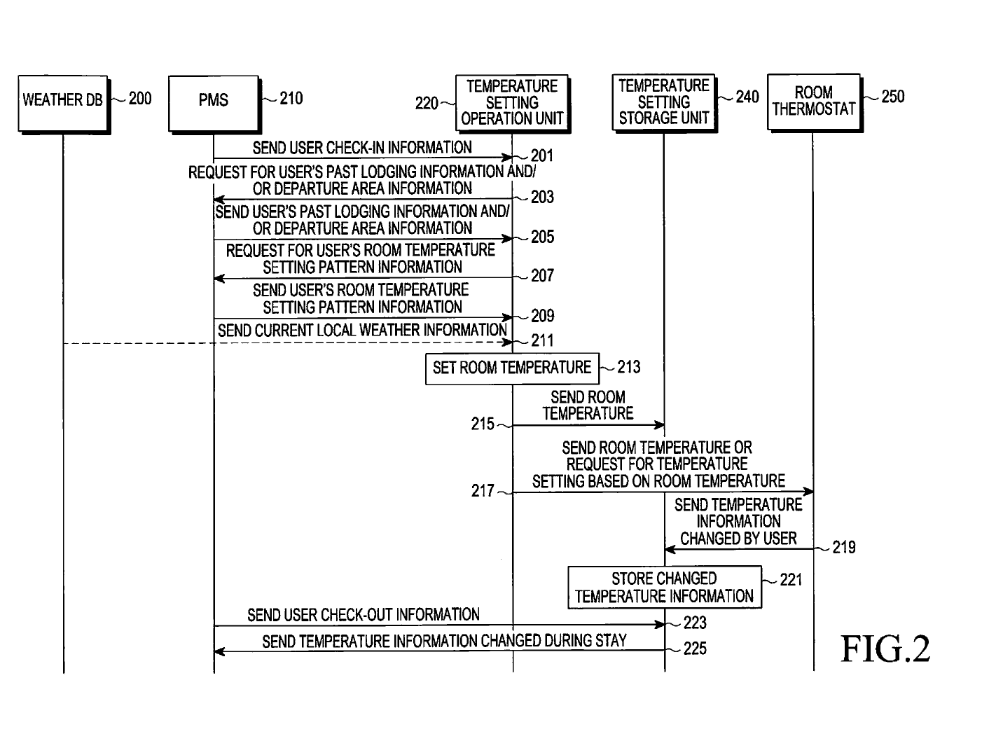

FIG. 2 is a flow diagram illustrating a control procedure between system components according to an embodiment of the present invention.

Referring to FIG. 2, the system according to an embodiment of the present invention includes a weather DB 200, a PMS 210, a temperature setting operation unit in a HVAC system, a temperature setting storage unit 240 in the HVAC system, and a room thermostat 250.

In step 201, the PMS 210 recognizes that the user checks in the hotel, and transmits the user check-in information to the temperature setting operation unit 220 in the HVAC system. The user check-in information includes, for example, information indicating that the user has arrived at the hotel.

Upon receiving the user check-in information, the temperature setting operation unit 220 sends a request for user's past lodging information and/or departure area information to the PMS 210 in step 203, and receives the user's past lodging information and/or departure area information from the PMS 210 in step 205. The user's past lodging information and/or departure area information includes the departure area information, the sojourn area information, the check-in time information, and the like. The departure area information may be obtained from the user's address, the phone number area code, or the flight information that the user entered during hotel reservation, all of which may be recorded in the PMS 210.

The temperature setting operation unit 220 in the HVAC system sends a request for user's room temperature setting pattern information to the PMS 210 in step 207, and receives the user's room temperature setting pattern information from the PMS 210 in response thereto in step 209.

The user's room temperature setting pattern information includes information about the check-in time and check-out time at the departure area or sojourn area, and the temperature and time given when there is a change in the room temperature setting by the user during the stay. The user's room temperature setting pattern information may further include the sensible temperature information given when there is a change in the room temperature setting.

The temperature setting operation unit 220 may send a request for current local weather information to the weather DB 200 (not shown), and receive the current local weather information from the weather DB 200 in response thereto in step 211. Although it is assumed in FIG. 2 that step 211 of receiving the current local weather information is performed after step 209 of receiving the user's room temperature setting pattern information, the weather information may be received at any other time (e.g., immediately after step 201 of receiving the user check-in information) regardless of the illustrated order.

The current local weather information includes information about the temperature, humidity, wind velocity, solar irradiation, and the like. The current local weather information may further include information about changes in weather, such as yellow dust, hail, hurricanes, and the like.

The above-described operation in which the HVAC system receives the current local weather information, the user's room temperature setting pattern information and the user's past lodging information and/or departure area information is presented as an operation of sending a request for the information to the PMS 210 and receiving the information from the PMS 210 in response thereto. However, the order (steps 205→209→211) of receiving the user's past lodging information and/or departure area information (in step 205), the user's room temperature setting pattern information (in step 209) and the current weather information (in step 211) may not be limited to the order presented in FIG. 2, and the above information may be received in any other order (e.g., steps 211→209→205).

Alternatively, upon receiving the user check-in information from the PMS in step 201, the temperature setting operation unit 220 in the HVAC system may receive the current local weather information (in step 211), the user's room temperature setting pattern information (in step 209) and the user's past lodging information and/or departure area information (in step 205) from the PMS 210 or the weather DB 200, without the procedure for requesting information. In this case, steps 203 and 207 are optional.

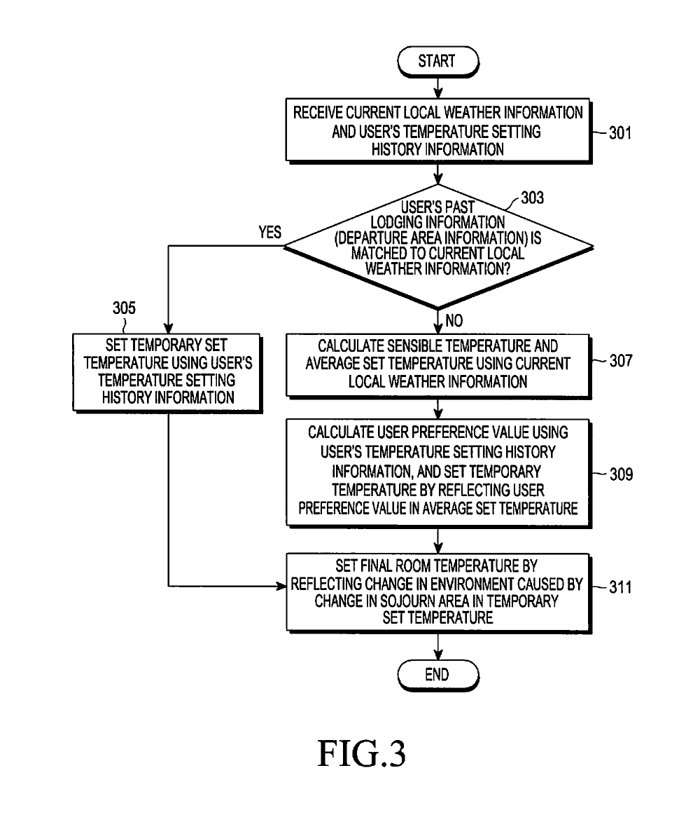

Upon receiving the current local weather information, the user's room temperature setting pattern information, and the user's past lodging information and/or departure area information, the temperature setting operation unit 220 sets the room temperature using at least one of the received information in step 213. For example, the temperature setting operation unit 220 determines the room temperature using all of the local weather information, the user's room temperature setting pattern information, and the user's past lodging information and/or departure area information. However, it is also possible to determine the room temperature using at least one of the above information. A process of setting the room temperature will be described in detail with reference to FIG. 3.

After determining the room temperature, the temperature setting operation unit 220 transmits the room temperature to the temperature setting storage unit 240 in step 215, and transmits the room temperature or sends a request for temperature setting to the room temperature to the room thermostat 250 in step 217. Steps 215 and 217 may be performed regardless of the order, or may be performed at the same time.

The room thermostat 250 sets the indoor environment depending on the room temperature. The room thermostat 250 is controlled so that the indoor temperature is set to a final set temperature.

Thereafter, if the indoor conditions are changed by the user, the room thermostat 250 transmits information about the indoor conditions (e.g., temperature information) changed by the user to the temperature setting storage unit 240 in the HVAC system in step 219. The room thermostat 250 includes at least one of a humidity control device and a wind speed control device (e.g., state conversion devices in the room, which are related to the temperature, humidity, and user's sensible temperature), which are installed in the room in advance. For example, if the user adjusts the temperature for the room temperature, and adjusts the humidity using a hygrometer, the room thermostat 250 sends information about the adjusted temperature and humidity in the room and the status information including information about the time the devices in the room were adjusted, to the temperature setting storage unit 240.

In step 221, the temperature setting storage unit 240 stores the received status information, that is, the changed information about the indoor conditions (e.g., changed temperature information).

If the user checks out the hotel, the PMS 210 sends user check-out information indicating the check-out of the user to the temperature setting storage unit 240 in step 223. In step 225, the temperature setting storage unit 240 sends the status information (e.g., temperature information changed during the stay) from the room thermostat 250 in the room where the use has stayed before his/her check out, to the PMS 210. The status information includes information about a temperature and the time the temperature is set, and may also include information about the humidity. Upon receiving the status information, the PMS 210 may additionally store or update the status information (e.g., the temperature setting history) in its user preference storage unit.

For example, if the user preference storage unit is not present in the PMS 210, the PMS 210 may store the user's past temperature setting information in an external server that is connected to the PMS 210 wirelessly or by wires, instead of storing the user's past temperature setting information in the PMS 210. Accordingly, the PMS 210 may receive the user's past temperature setting information from the external server, and utilize the received user's past temperature setting information. The user's past temperature setting information includes at least one of the user's room temperature setting pattern information and the user's past lodging information and/or departure area information.

The below-described process of setting the room temperature may correspond to an operation of the temperature setting operation unit 220 in the HVAC system.

FIG. 3 is a flowchart illustrating a process of setting a room temperature according to an embodiment of the present invention.

Referring to FIG. 3, in step 301, the temperature setting operation unit receives the current local weather information and the user's temperature setting history information, including the user's room temperature setting pattern information and the user's past lodging information and/or departure area information. The temperature setting operation unit may receive each of the above information regardless of the order. The temperature setting operation unit may receive the user's room temperature setting pattern information and the user's past lodging information and/or departure area information, which are stored in the PMS, from the PMS, and receive the current local weather information, which is stored in the weather DB, from the weather DB.

As an example, the information stored in the PMS has the structure defined in Table 1.

TABLE 1

| Location | Time (Hour/Month/Day/Year) | Set temperature | User |
|---|---|---|---|
| Seoul | 10 AM/7/25/2013 | 25 | A |
| Busan | 5 PM/9/14/2013 | 24 | A |
| Seoul | 5 PM/9/13/2013 | 19 | B |
| Busan | 5 PM/9/14/2013 | 18 | B |
| Busan | 5 PM/9/14/2012 | 20 | B |
| Busan | 5 PM/9/14/2013 | 20 | C |

The temperature setting operation unit may further receive the sensible temperature corresponding to the period, which is stored in the PMS, from the PMS, in addition to the location and time information.

As another example, the information stored in the PMS has the structure defined in Table 2.

TABLE 2

| | Time | Sensible | Set | |
|---|---|---|---|---|
| Location | (Hour/Month/Day/Year) | Temperature | Temperature | User |
| Seoul | 10 AM/7/25/2013 | 30 | 25 | A |
| Busan | 5 PM/9/14/2013 | 23 | 24 | A |
| Seoul | 5 PM/9/13/2013 | 30 | 19 | B |
| Busan | 5 PM/9/14/2013 | 23 | 18 | B |
| Busan | 5 PM/9/14/2012 | 23 | 20 | B |
| Busan | 5 PM/9/14/2013 | 23 | 20 | C |

It will be assumed herein that users A, B and C in Busan have the same sensible temperature because they all stay in the same place (e.g., Busan) at the same time (e.g., 5PM/9/14/2013). The sensible temperatures may be calculated by the temperature setting operation unit. Table 2 illustrates the sensible temperatures, which are calculated by the temperature setting operation unit using the weather information received from the weather DB, and are stored in the PMS. For example, in order to calculate the sensible temperatures, the temperature setting operation unit may receive the location and time information from the PMS, and receive the temperature, humidity, wind direction, and solar irradiation information corresponding to the location and time information from the weather DB.

As an example, the information stored in the weather DB has the structure defined in Table 3.

TABLE 3

| | | Temperature | | Wind Velocity | Solar |
|---|---|---|---|---|---|
| Location | Time | (T) | Humidity (H) | (m/s) | Irradiation (J) |
| Seoul | 5 PM/9/13/2013 | 26 | 10 | 0 | 10 |
| Busan | 5 PM//9/14/2013 | 27 | 20 | 20 | 3 |
| Busan | 5 PM//9/14/2012 | 27 | 20 | 20 | 3 |

As another example, the information stored in the weather DB has the structure defined in Table 4.

TABLE 4

| | | Temperature | Humidity | Wind Velocity | Solar Irradiation | Sensible |
|---|---|---|---|---|---|---|
| Location | Time | (T) | (H) | (m/s) | (J) | Temperature |
| Seoul | 5PM/9/13/2013 | 26 | 10 | 0 | 10 | 30 |
| Busan | 5PM//9/14/2013 | 27 | 20 | 20 | 3 | 23 |
| Busan | 5PM//9/14/2012 | 27 | 20 | 20 | 3 | 23 |

In other words, the temperature setting operation unit may receive the temperature, humidity, wind velocity, solar irradiation and sensible temperature information (Table 4) from the weather DB using the location, time and user information presented in Table 1, or may directly calculate the sensible temperature (Table 3) using the temperature, humidity, wind velocity, and solar irradiation information.

In step 303, using the received information, the temperature setting operation unit determines whether the current local weather information is matched to the user's temperature setting history information.

As an example, the operation of determining the match/mismatch may be an operation of determining whether information about the temperature T(L_{local},t_{current}), humidity H(L_{local},t_{current}), wind velocity W(L_{local},t_{current}) and solar irradiation S(L_{local},t_{current}) in the area where the user is currently located, which is obtained from the weather DB, is matched to the temperature, humidity, wind velocity and solar irradiation information determined during the user's past temperature setting, which is recorded in the PMS.

As another example, the operation of determining the match/mismatch may be an operation of determining whether the weather information determined during the user's past temperature setting, which is recorded in the PMS, is present in a predetermined threshold range of the current local weather information (e.g., temperature, humidity, wind velocity and solar irradiation) obtained from the weather DB. For example, it is determined that the temperature is matched, if the temperature falls within a range of ±1° of the current local temperature; it is determined that the humidity is matched, if the humidity falls within a range of ±2% of the current local humidity; it is determined that the wind velocity is matched, if the wind velocity falls within a range of ±2 m/sec of the current local wind velocity; and it is determined that the solar irradiation is matched, if the solar irradiation falls within a range of ±1 kcal/m²h of the current local solar irradiation.

Determining the match/mismatch may correspond to comparing all of four types of weather information (e.g., temperature, humidity, wind velocity, and solar irradiation), or comparing only some of the four types of weather information. For example, determining the match/mismatch corresponds to only determining whether the temperature T is matched, or determining whether the temperature T and the humidity H are matched. If the information being compared is not present in either side of the comparison, the information may be ignored in the calculation. As an example, when the current local weather information includes information about the temperature, humidity, wind velocity and solar irradiation, and the user's past lodging information and/or departure area information includes only the temperature, humidity and wind velocity information, since comparison of the solar irradiation is impossible, the temperature setting operation unit ignores the comparison of the solar irradiation when comparing the user's past lodging information and/or departure area information with the current weather information; alternatively, the temperature setting operation unit uses predetermined solar irradiation information to be added to the user's past lodging information and/or departure area information that does not include information about the solar irradiation.

The temperature T(L_{local},t_{current}) represents the temperature in the current location at the current time. The humidity H(L_{local},t_{current}) represents the humidity in the current location at the current time. The wind velocity W(L_{local},t_{current}) represents the wind velocity in the current location at the current time. The solar irradiation S(L_{local},t_{current}) represents the solar irradiation in the current location at the current time.

In the following description, a case where the current local weather information is matched to the weather information included in the user's temperature setting history information will be given as a first example, and a case where the current local weather information is not matched to the weather information included in the user's temperature setting history information will be given as a second example.

In the first example, if T(L_{local},t_{current}), H(L_{local},t_{current}), W(L_{local},t_{current}) and S(L_{local},t_{current}) are matched with those of the user's temperature setting history information, the temperature setting operation unit sets the set temperature in the user's temperature setting history information (e.g., the user's room temperature setting pattern information) as the temporary set temperature Tₛₑₜ in step 305.

For example, it is assumed that a user B was under an environment having a temperature of 27°, a humidity of 20%, a wind velocity of 20 m/sec and a solar irradiation of 3 kcal/m²h, when the user B stayed in Busan at 5:00 pm, Sep. 14, 2012, and the user B has the same weather information (e.g., a temperature of 27°, a humidity of 20%, a wind velocity of 20 m/sec and a solar irradiation of 3 kcal/m²h) in Busan at the present time (e.g., 5:00 pm, Sep. 14, 2013). The temperature setting operation unit determines the set temperature of 20°, which was set when the user B stayed in Busan at 5:00 pm, Sep. 14, 2012, a temporary set temperature Tₛₑₜ.

In the second example, if T(L_{local},t_{current}), H(L_{local},t_{current}), W(L_{local},t_{current}) and S(L_{local},t_{current}) are not matched with those of the user's temperature setting history information, the temperature setting operation unit calculates a sensible temperature by using the current local weather information (e.g., the temperature T(L_{local},t_{current}), humidity H(L_{local},t_{current}), wind velocity W(L_{local},t_{current}) and solar irradiation S(L_{local},t_{current}) in the area where the user is currently located) in step 307.

The temperature setting operation unit calculates the sensible temperature ST using the T(L_{local},t_{current}), H(L_{local},t_{current}), W(L_{local},t_{current}) and S(L_{local},t_{current}) received from the weather DB. For example, the sensible temperature ST may be expressed as ST(T(L_{local},t_{current}), H(L_{local},t_{current}), W(L_{local},t_{current}), S(L_{local},t_{current})). There may be a variety of methods (e.g., equations) for calculating the sensible temperature using the weather information. Any method of determining the sensible temperature using information about at least one of the temperature, humidity, wind velocity and solar irradiation may be applied. In step 307, the temperature setting operation unit also calculates an average value of the set temperatures that are set by all users at the sensible temperature, on the basis of the calculated sensible temperature, using the current local weather information.

For example, if a user A presented in Table 1 first stays in Busan, the temperature setting operation unit receives values of the current temperature (e.g., 27°), humidity (e.g., 20%), wind velocity (e.g., 20 m/sec) and solar irradiation (e.g., 3 kcal/m²h) in Busan (current location) from the weather DB. The temperature setting operation unit calculates the sensible temperature using the received temperature (e.g., 27°), humidity (e.g., 20%), wind velocity (e.g., 20 m/sec) and solar irradiation (e.g., 3 kcal/m²h).

Using the calculated sensible temperature (e.g., 23°), the temperature setting operation unit calculates an average set temperature value of the set temperatures that are set by all users at the same calculated sensible temperature (e.g., 23°). The average set temperature value of the set temperatures that are set by all users may be expressed as ‘average(RT_all(ST(T(L_{local},t_{current}), H(L_{local},t_{current}), W(L_{local},t_{current}), S(L_{local},t_{current}))))’.

For example, referring to Table 2, a user A has set the set temperature to 24° at the sensible temperature of 23°, a user B has set the set temperature to either 18° or 20° at the sensible temperature of 23°, and a user C has set the set temperature to 20° at the same sensible temperature of 23°. Accordingly, the temperature setting operation unit determines the average set temperature value of the set temperatures that are set by all users at the sensible temperature, as (24+18+20+20)/4=20.5°, which is an average value of the set temperatures which are set by the users A, B and C.

In step 309, the temperature setting operation unit calculates a regulation value (a value indicating whether the user has set a set temperature (in the user's temperature setting history information) higher than the average set temperature determined in step 307, or lower than the average set temperature determined in step 307) corresponding to the user's preference using the user's temperature setting history information, and sets a temporary set temperature by reflecting the regulation value corresponding to the user's preference compared with the average set temperature determined in step 307.

Specifically, calculating a regulation value (e.g., RT_individual) corresponding to the user's preference may correspond to calculating an average of difference values between the average set temperature and the user's preferred set temperatures on the basis of the sensible temperature.

An equation for calculating RT_individual is given in Equation (1):

RT_individual=average(Tᵣₒₒₘ−average(RT_{—}all(ST(T(Lₐᵣᵣᵢᵥₐₗ,tᵣₒₒₘ),H(Lₐᵣᵣᵢᵥₐₗ,tᵣₒₒₘ),W(Lₐᵣᵣᵢᵥₐₗ,tᵣₒₒₘ),S(Lₐᵣᵣᵢᵥₐₗ,tᵣₒₒₘ))))) (1)

where Tᵣₒₒₘ denotes the set temperature that is set by the user at the sensible temperature in the past, Lₐᵣᵣᵢᵥₐₗ denotes the location of the arrival area, and tᵣₒₒₘ denotes the time the user set the set temperature Tᵣₒₒₘ in the past. However, if there is no user's temperature setting history at the sensible temperature, a value of RT_individual may be set to a value of ‘0’, instead of being calculated by above equation.

For example, if a value of ‘2’ is obtained as an average of differences between the average set temperature and the user's preferred set temperatures, this value is a regulation value corresponding to the user's preference. That is, the user A has set the set temperature to be a higher temperature on average, compared with the average set temperature that are set by all users. In other words, in step 309, the temperature setting operation unit determines a temporary set temperature Tₛₑₜ by reflecting the calculated regulation value RT_individual corresponding to the user's preference compared with the average set temperature calculated in step 307.

An equation for determining the temporary set temperature Tₛₑₜ is expressed as shown in Equation (2):

Tₛₑₜ=average(RT_{—}all(ST(T(L_{local},t_{current}),H(L_{local}t_{current}),W(L_{local},t_{current}),S(L_{local},t_{current}))))+RT_individual (2)

where RT_individual denotes the regulation value corresponding to the user's preference, and average(RT_all(ST(T(L_{local},t_{current}), H(L_{local},t_{current}), W(L_{local},t_{current}), S(L_{local},t_{current})))) denotes the average set temperature at a specific sensible temperature calculated in step 307.

In step 311, the temperature setting operation unit reflects additional temperature control corresponding to a change in the user's sojourn area in the temporary set temperature determined in the first example (or step 305) and/or in the temporary set temperature determined in the second example (or step 309). The term ‘change in sojourn area’ used herein may mean all changes from the previous sojourn area to the current sojourn area due to the user's travel, and the like.

For example, the user B now stays in Busan at 5:00 pm, Sep. 14, 2013, under an environment having a temperature of 27°, a humidity of 20%, a wind velocity of 20 m/sec and a solar irradiation of 3 kcal/m²h as presented in Tables 3 and 4. The user B was staying in Seoul at 5:00 pm, Sep. 13, 2013, under an environment having a temperature of 26°, a humidity of 10%, a wind velocity of 0 m/sec and a solar irradiation of 10 kcal/m²h as presented in Tables 3 and 4.

In this case, the temperature setting operation unit reflects the change in the indoor temperature control corresponding to the change in the sojourn area of the user B. The change in the indoor temperature control corresponding to the change in the sojourn area may be calculated using a temperature setting difference function ‘f’.

Equation (3) below represents the temperature setting difference function for additional temperature control corresponding to the change in the sojourn area.

f(T(Lₐᵣᵣᵢᵥₐₗ,tᵢₙ)−T(L_{depart},tᵢₙ),H(Lₐᵣᵣᵢᵥₐₗ,tᵢₙ)−H(L_{depart},tᵢₙ),W(Lₐᵣᵣᵢᵥₐₗ,tᵢₙ)−W(L_{depart},tᵢₙ),S(Lₐᵣᵣᵢᵥₐₗ,tᵢₙ)−S(L_{depart},tᵢₙ)) (3)

where Lₐᵣᵣᵢᵥₐₗ denotes the location of the arrival area, L_{depart} denotes the location of the departure area, and tᵢₙ denotes the check-in time at the arrival area or the departure area.

As for a specific function for determining a temperature setting difference using the weather information, there may be a variety of method besides Equation (3), and any functions for determining a temperature setting difference using the temperature, humidity, wind velocity and solar irradiation information may be applied.

For example, the change in the indoor temperature control may be calculated by a function ‘f’ of f((27-26, 20-10, 20-0, 3-10), using differences between values of the temperature of 27°, the humidity of 20%, the wind velocity of 20 m/sec and the solar irradiation of 3 kcal/m²h given when the user B stays in Busan at 5:00 pm, Sep. 14, 2013, and values of the temperature of 26°, the humidity of 10%, the wind velocity of 0 m/sec and the solar irradiation of 10 kcal/m²h given when the user B was staying in Seoul at 5:00 pm, Sep. 13, 2013.

In step 311, the temperature setting operation unit sets the final set temperature by reflecting the additional temperature control corresponding to the change in the sojourn area (e.g., adding the additional temperature control value to the temporary set temperature Tₛₑₜ calculated in step 305 or step 309). Alternatively, in step 311, the temperature setting operation unit may set the final set temperature by adding the additional temperature control value corresponding to the change in the sojourn area to the temporary set temperature Tₛₑₜ calculated in step 309.

The final set temperature corresponding to the weather difference between the user's departure area and arrival area using the temperature setting difference function corresponding to the change in the sojourn area may be expressed as shown in Equation (4):

Tset_final=Tₛₑₜ+f(T(L_{local},t_{current})−T(L_{depart},tₚₐₛₜ),H(L_{local},t_{current})−H(L_{depart},tₚₐₛₜ),W(L_{local},t_{current})−W(L_{depart},tₚₐₛₜ),S(L_{local},t_{current})−S(L_{depart},tₚₐₛₜ)) (4)

where Tset_final denotes the final set temperature in which a temperature difference corresponding to the change in the sojourn area is reflected, Tₛₑₜ denotes the temporary set temperature determined in the first example or the second example, ‘f’ denotes the temperature setting difference function in Equation (3), L_{local}, t_{current} denote the location where the user currently stays and the time the user currently stays, and L_{depart}, tₚₐₛₜ denote the location where the user has stayed in the past and the time the user has stayed in the past. The time at which the temperature, humidity, wind direction and solar irradiation are measured in the location where the user currently stays, may be the same as the time at which the temperature, humidity, wind direction and solar irradiation were measured in the location where the user has stayed in the past.

Accordingly, the temperature setting operation unit may set the final set temperature by reflecting the change in the additional indoor temperature control corresponding to the change in the sojourn area. The room thermostat may be controlled so that the indoor temperature may be set to the final set temperature.

As is apparent from the foregoing description, in the absence of people in a public building such as accommodations and hospitals, the HVAC system may be set according to the minimum requirements, contributing to the energy savings.

If there is a person in the public building, the HVAC system may be automatically set to meet the conditions preferred by the person, thereby increasing the user satisfaction.

The HVAC system may control the indoor temperature by collecting the weather information and the personal preferences, thereby efficiently reflecting the user's situation.

Instead of simply controlling the indoor temperature, the HVAC system may provide the indoor environment corresponding to the user's sensible temperature using the weather information of the user's departure area, taking into account the changing user's environment even when the user's environment is significantly changed.

While the invention has been shown and described with reference to certain embodiments thereof, it will be understood by those skilled in the art that various changes in form and details may be made therein without departing from the spirit and scope of the present invention as defined by the appended claims and their equivalents.

What is claimed is:

1. A method for controlling an indoor temperature based on information about a user, the method comprising:
determining a temporary set temperature using weather information of user's current location and current time; and
determining a final set temperature by reflecting a change in the weather information caused by movement of the user based on the temporary set temperature.

2. The method of claim 1, wherein the change in the weather information includes a difference between each of a temperature, a humidity, a wind velocity and a solar irradiation in a current location and each of a temperature, a humidity, a wind velocity and a solar irradiation in a previous location.

3. The method of claim 1, wherein the weather information includes information about at least one of a temperature, a humidity, a wind velocity, and a solar irradiation.

4. The method of claim 1, wherein determining the temporary set temperature comprises:
obtaining user's temperature setting history information from an external server;
obtaining the weather information of the user's current location and current time from a weather Database (DB);
determining whether past weather information included in the user's temperature setting history information is matched to the weather information of the user's current location and current time; and
determining the temporary set temperature depending on a result of the match determination.

5. The method of claim 4, wherein the external server includes a Property Management System (PMS).

6. The method of claim 5, wherein determining the temporary set temperature depending on the result of the match determination comprises determining a set temperature included in the user's temperature setting history information as the temporary set temperature, if the past weather information included in the user's temperature setting history information is matched to the weather information of the user's current location and current time.

7. The method of claim 5, wherein determining the temporary set temperature depending on the result of the match determination comprises:
if the past weather information included in the user's temperature setting history information is not matched to the weather information of the user's current location and current time, calculating a sensible temperature using the weather information of the user's current location and current time;
calculating an average set temperature based on an average value of set temperatures of all users based on the sensible temperature;
calculating a regulation value corresponding to a user's preference based on the sensible temperature; and
determining the temporary set temperature by adding the regulation value corresponding to the user's preference to the average set temperature.

8. The method of claim 7, wherein the regulation value corresponding to the user's preference is an average value of a difference between a set temperature included in the user's temperature setting history information and the average set temperature based on the sensible temperature.

9. The method of claim 1, further comprising controlling a thermostat in a room so that the indoor temperature is set to the final set temperature.

10. An apparatus for controlling an indoor temperature based on information about a user, the apparatus comprising:
a temperature setting operation unit configured to determine a temporary set temperature using weather information of user's current location and current time, and to determine a final set temperature by reflecting a change in the weather information caused by movement of the user based on the temporary set temperature; and
a communication unit configured to exchange information with an external device under control of the temperature setting operation unit.

11. The apparatus of claim 10, wherein the change in the weather information includes a difference between each of a temperature, a humidity, a wind velocity and a solar irradiation in a current location and each of a temperature, a humidity, a wind velocity and a solar irradiation in a previous location.

12. The apparatus of claim 10, wherein the weather information includes information about at least one of a temperature, a humidity, a wind velocity and a solar irradiation.

13. The apparatus of claim 9, wherein the temperature setting operation unit is further configured to:
obtain user's temperature setting history information from an external server;
obtain the weather information of the user's current location and current time from a weather Database (DB);
determine whether past weather information included in the user's temperature setting history information is matched to the weather information of the user's current location and current time; and
determine the temporary set temperature depending on a result of the match determination.

14. The apparatus of claim 13, wherein the external server includes a Property Management System (PMS).

15. The apparatus of claim 14, wherein the temperature setting operation unit is further configured to determine a set temperature included in the user's temperature setting history information as the temporary set temperature, if the past weather information included in the user's temperature setting history information is matched to the weather information of the user's current location and current time.

16. The apparatus of claim 14, wherein the temperature setting operation unit is further configured to:
if the past weather information included in the user's temperature setting history information is not matched to the weather information of the user's current location and current time, calculate a sensible temperature using the weather information of the user's current location and current time;
calculate an average set temperature based on an average value of set temperatures of all users based on the sensible temperature;
calculate a regulation value corresponding to a user's preference based on the sensible temperature, and
determine the temporary set temperature by adding the regulation value corresponding to the user's preference to the average set temperature.

17. A Heating Ventilation and Air Conditioning (HVAC) system for controlling an indoor temperature based on information about a user, the HVAC system comprising:
a temperature setting operation unit configured to determine a temporary set temperature using weather information of user's current location and current time, and to determine a final set temperature by reflecting a change in the weather information caused by movement of the user based on the temporary set temperature; and
a communication unit configured to exchange information with an external device under control of the temperature setting operation unit.
